(19) United States
(12) Patent Application Publication
(10) Pub. No.: US 2015/0228367 A1
(43) Pub. Date: Aug. 13, 2015

(54) RADIOACTIVE MATERIAL PROCESSING METHOD

(71) Applicant: KABUSHIKI KAISHA TOSHIBA, Tokyo (JP)

(72) Inventors: Yuya Takahashi, Kawasaki (JP); Koji Mizuguchi, Kawasaki (JP); Hitoshi Nakamura, Yokohama (JP); Shohei Kanamura, Kawasaki (JP); Reiko Fujita, Nerima (JP); Takashi Oomori, Adachi (JP); Akira Ikeda, Naka (JP)

(73) Assignee: KABUSHIKI KAISHA TOSHIBA, Minato-ku, Tokyo (JP)

(21) Appl. No.: 14/435,022

(22) PCT Filed: Oct. 11, 2013
(86) PCT No.: PCT/JP2013/077757

§ 371 Date: Apr. 10, 2015

(30) Foreign Application Priority Data
Oct. 12, 2012 (JP) 2012-227328

(51) Int. Cl. G21F 9/30; G21F 9/12

(52) U.S. Cl. CPC G21F 9/308; G21F 9/12

(57) ABSTRACT

A corium processing method includes a dissolution step of feeding the corium into a first molten salt and dissolving uranium oxide and plutonium oxide contained in an oxide solid from the corium; a nuclear fuel recovery step of recovering the uranium oxide and the plutonium oxide from the first molten salt; a metal recovery step of feeding the corium into a second molten salt and separating and recovering metal Fe and metal Zr by molten salt electrolysis; and a solidification step of solidifying and recovering residues of the corium.

### TECHNICAL FIELD

Embodiments of the present invention relate to a processing method for radioactive materials such as corium produced as a result of a nuclear accident, the radioactive materials containing metal Fe, metal Zr, uranium oxide, and plutonium oxide.

### BACKGROUND ART

Conventionally, processing techniques for radioactive materials in a normal nuclear fuel cycle have been proposed, including reprocessing of spent nuclear fuel and disposal of radioactive waste in nuclear power generation (see, for example, Patent Documents 1 to 4).

### PRIOR ART DOCUMENTS

### Patent Documents

Patent Document 1: Japanese Patent No. 3868635

Patent Document 2: Japanese Patent No. 3940632

Patent Document 3: Japanese Patent No. 4487031

Patent Document 4: Japanese Patent No. 4533514

### SUMMARY OF THE INVENTION

### Problems to be Solved by the Invention

When reactor cooling capacity is lost as a result of a nuclear accident, fuel assemblies and core structures may be overheated and molten by decay heat of nuclear fuel, producing corium. There is no effective means of reprocessing the corium which contains radiation materials and whose soundness has been damaged, and thus the corium is stored as it is as waste. Therefore, there is a problem in that it is not possible to reduce amounts of radioactive waste generation and that heavy loads are placed on storage and management.

In the corium, also known as fuel debris, various materials such as iron-based materials of a pressure vessel and in-core and ex-core structures, zirconium materials of fuel cladding and channel boxes, oxide fuel (uranium oxide and plutonium oxide) contained in nuclear fuel, and FP (fission product) oxides are mixed heterogeneously.

Techniques in Patent Documents 1 to 4 are each designed to reprocess unmixed oxide fuel and metallic materials using respective separate treatment processes. Thus, the techniques are not intended for oxide fuel such as corium containing large amounts of mixed metals.

Also, uranium oxide, zirconium oxide, zirconium, and iron are mixed and dissolved in corium. Uranium oxide and zirconium oxide, when molten and mixed, form stable solid solution ((U,Zr)O₂) which is difficult to dissolve in nitric acid. Therefore, there is a problem in that treatment based on the PUREX process, which is a typical nuclear fuel extraction separation method involving dissolution in nitric acid, is difficult to apply to corium.

The present invention has been made in view of the above circumstances and has an object to provide a radioactive material processing method for separating and recovering uranium oxide and plutonium oxide which are nuclear fuels as well as Fe and Zr which are metallic materials from radioactive materials.

### Means for Solving the Problems

A radioactive material processing method according to an embodiment of the present invention comprises: a dissolution step of feeding corium into a first molten salt and dissolving uranium oxide and plutonium oxide contained in an oxide solid from the corium; a nuclear fuel recovery step of recovering the uranium oxide and the plutonium oxide from the first molten salt; a metal recovery step of feeding the corium into a second molten salt and separating and recovering metal Fe and metal Zr by molten salt electrolysis; and a solidification step of solidifying and recovering residues of the corium.

In the radioactive material processing method which has the features described above, desirably the first molten salt is molten molybdate or molten tungstate.

Also, the radioactive material processing method may further comprise a step of feeding the corium into an acid solvent before the dissolution step to dissolve the uranium oxide and the plutonium oxide not contained in the oxide solid.

Also, the nuclear fuel recovery step may recover the uranium oxide and the plutonium oxide by molten salt electrolysis or high temperature crystallization, where the high temperature crystallization involves precipitating nuclear fuel material by heating the first molten salt.

Furthermore, after cooling and solidifying and then dissolving the first molten salt in an acid solvent, the nuclear fuel recovery step can recover the uranium oxide and the plutonium oxide using one of separation methods: a method which uses a cation exchange resin or a chelate resin, a method which adds oxalic acid, and a method which uses an extractant for extraction and separation.

### Advantages of the Invention

As described above, the present invention makes it possible to recover metal Fe and metal Zr having a large volume in corium and fissile nuclides and minor actinoids with high radiation dosage by separating the former from the latter and thereby reduce high-level radioactive waste in volume. Further advantages of the present invention will become more apparent from the following description of an embodiment with reference to the accompanying drawings.

### BRIEF DESCRIPTION OF THE DRAWINGS

FIG. 1 is a flowchart showing a radioactive material processing method according to a first embodiment of the present invention.

FIG. 2 is a flowchart showing a radioactive material processing method according to a second embodiment of the present invention.

FIG. 3 is a flowchart showing a radioactive material processing method according to a third embodiment of the present invention.

FIG. 4 is a flowchart showing a radioactive material processing method according to a fourth embodiment of the present invention.

### DESCRIPTION OF EMBODIMENTS

### First Embodiment

Embodiments of the present invention will be described below with reference to the accompanying drawings.

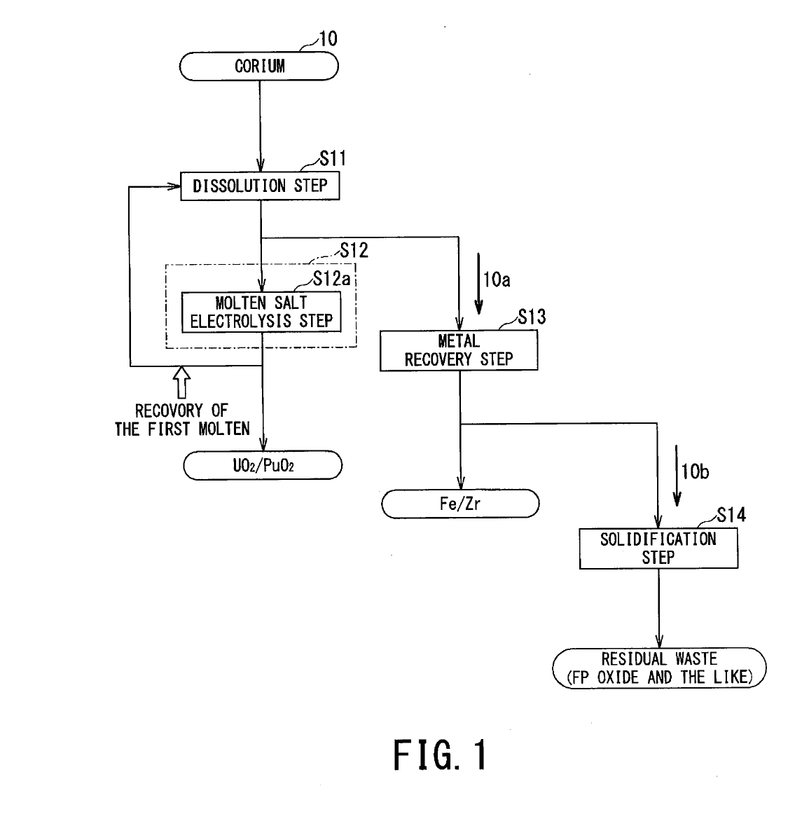

FIG. 1 shows a flowchart of a processing method according to a first embodiment for radioactive materials, such as corium, containing metal Fe, metal Zr, uranium oxide, and plutonium oxide (hereinafter abbreviated to the corium 10). The processing method includes a dissolution step S11 of feeding the corium 10 into a first molten salt and dissolving uranium oxide and plutonium oxide contained in an oxide solid from the corium 10; a nuclear fuel recovery step S12 of recovering the uranium oxide and the plutonium oxide from the first molten salt; a metal recovery step S13 of feeding the corium 10a into a second molten salt and separating and recovering the metal Fe and metal Zr by molten salt electrolysis; and a solidification step S14 of solidifying and recovering residues of the corium 10b. Regarding the corium 10, the corium 10a remaining after the dissolution step S11 and the corium 10b remaining after the metal recovery step S13 are distinguished from each other.

The corium 10 is a unified matter produced after Fe-based materials constituting a pressure vessel, Zr materials constituting fuel cladding and channel boxes, zirconium oxide, uranium oxide (UO₂) and plutonium oxide (PuO₂) constituting nuclear fuel, FP oxide, and concrete are molten and mixed by decay heat and then cooled and solidified. Also, the corium 10 includes the oxide solid formed in a solidification process (oxide solid ((U,Zr)O₂) of uranium oxide and zirconium oxide, in particular).

In the dissolution step S11, the corium 10 is fed into the first molten salt, and the uranium oxide and plutonium oxide contained in the oxide solid in the corium 10 are dissolved in the first molten salt.

Therefore, in addition to the uranium oxide and plutonium oxide contained in the corium 10 without forming solid solution, the uranium oxide and plutonium oxide contained in the oxide solid are selectively dissolved in the first molten salt.

Molten molybdate or molten tungstate is used as the first molten salt. A mixed salt of molybdenum oxide and sodium molybdate is suitable as the molten molybdate while a mixed salt of tungsten oxide and sodium tungstate is suitable as the molten tungstate. Note that the first molten salt is heated to 700 to 800° C. to accelerate dissolution reaction.

Also, the first molten salt may have the sodium molybdate in the mixed salt of molybdenum oxide and sodium molybdate replaced with one of potassium molybdate, rubidium molybdate, cesium molybdate, magnesium molybdate, calcium molybdate, and strontium molybdate.

Similarly, the sodium tungstate in the mixed salt of tungsten oxide and sodium tungstate may be replaced with one of potassium tungstate, rubidium tungstate, cesium tungstate, magnesium tungstate, calcium tungstate, and strontium tungstate.

Also, a step of feeding the corium 10 into an acid solvent such as nitric acid and dissolving the uranium oxide and plutonium oxide which does not form an oxide solid may be inserted before the dissolution step S11. This makes it possible to dissolve uranium oxide and plutonium oxide in the acid solvent such as nitric acid in that part of the corium 10 which contains a large amount of uranium oxide. The uranium oxide and plutonium oxide dissolved in the acid solvent can be separated and recovered using the PUREX process.

On the other hand, that part of the corium 10 which makes up an oxide solid does not dissolve in acid solvents such as nitric acid. Therefore, in the dissolution step S11, the uranium oxide and plutonium oxide contained in the oxide solid are selectively dissolved in the first molten salt.

In this way, by providing a step of feeding corium 10 into an acid solvent before the dissolution step S11, it is possible to feed the corium 10 into the first molten salt after volume reduction.

Note that nitric acid, sulfuric acid, hydrochloric acid, hydrofluoric acid, boric acid, formic acid, acetic acid, potassium pyrosulfate, sodium pyrosulfate, calcium pyrosulfate, magnesium pyrosulfate, ammonium pyrosulfate, or a mixture thereof can be used here as the acid solvent.

The nuclear fuel recovery step S12 includes a molten salt electrolysis step S12a, which separates and recovers the uranium oxide and plutonium oxide from the first molten salt.

The molten salt electrolysis step S12a is carried out by placing an electrode in the first molten salt in which the uranium oxide and plutonium oxide have dissolved. Then, the uranium oxide and plutonium oxide are separated and recovered by being precipitated on the electrode.

The uranium oxide and plutonium oxide dissolved in the first molten salt are ionized as UO₂²⁺ and PuO2₂⁺, respectively. When a voltage is applied by placing an anode and cathode in the first molten salt, electrolytic reduction reaction given by the following formula (1) occurs on the cathode.

Cathode: UO₂²⁺+PuO₂²⁺+4ₑ⁻→UO₂+PuO₂ (1)

As a result of the reaction given by formula (1), ionized UO₂²⁺and PuO₂²⁺precipitate as uranium oxide and plutonium oxide on the cathode. By recovering the cathode, it is possible to selectively separate and recover a mixture (MOX) of uranium oxide and plutonium oxide from the corium 10. Note that the first molten salt used in the molten salt electrolysis step S12a can be recovered and reclaimed, and then reused in the dissolution step S11.

In the metal recovery step S13, the corium 10a is fed into the second molten salt, and the metal Fe and metal Zr are recovered by being separated by molten salt electrolysis.

As the second molten salt, any of the following mixed salts can be used: sodium chloride and potassium chloride, rubidium chloride and sodium chloride, cesium chloride and sodium chloride, rubidium chloride and potassium chloride, cesium chloride and potassium chloride, sodium chloride and magnesium chloride, sodium chloride and calcium chloride, potassium chloride and strontium chloride, potassium chloride and calcium chloride, sodium fluoride and potassium fluoride, lithium fluoride and potassium fluoride, sodium fluoride and lithium fluoride, sodium chloride and sodium fluoride, and potassium chloride and potassium fluoride.

A molten salt electrolysis method performed by feeding the corium 10a into the second molten salt will be described concretely below.

First, in the dissolution step S11, corium 10a containing the metal Fe, metal Zr, zirconium oxide, FP oxide, and the like not dissolved in the first molten salt is taken out. The corium 10a taken out and intended for use as an anode is put in a basket (not shown) and then placed in the second molten salt together with a cathode made of an iron-based material. Then, a voltage is applied by connecting the anode and cathode together.

After the voltage application, metal Zr whose oxidation-reduction potential is more electropositive dissolves into the second molten salt from out of the corium 10a and precipitates on the cathode due to electrolytic reduction. This makes it possible to recover the metal Zr precipitated on the cathode. At this time, electrolytic reactions given by formulae (2) and (3) below occur on the anode and cathode.

Anode: Zr→Zr⁴⁺+4e⁻ (2)

Cathode: Zr⁴⁺+4e−→Zr (3)

Furthermore, when the voltage is continued to be applied by changing the cathode, metal Fe dissolves into the second molten salt from out of the corium 10a and precipitates on the cathode. This makes it possible to recover the metal Fe precipitated on the cathode. At this time, electrolytic reactions given by formulae (4) and (5) below occur on the anode and cathode.

Anode: Fe→Fe²⁺⁽³⁺⁾+2e−(3e⁻) (4)

Cathode: Fe²⁺⁽³⁺⁾+2e⁻⁽3e⁻)→Fe (5)

This makes it possible to separate and recover metal Fe and metal Zr from the corium 10a remaining after the dissolution step.

On the other hand, fission products (FPs) and minor actinoids which deliver high radiation doses in the corium 10a drop to a bottom of the basket (not shown) at the anode and remains there.

The solidification step S14 is designed to recover and solidify the corium 10b, i.e., the residues remaining after the metal recovery step S13. The recovered corium 10b is residual material made up of zirconium oxide, FP oxide, and concrete. In particular, the FP oxide and concrete contain fissile nuclides and minor actinoids and deliver high radiation doses.

The corium 10b is just taken out of the second molten salt after the metal recovery step S13 or recovered by solidifying the second molten salt by natural cooling. By being vitrified, the recovered corium 10b is stored and managed as stable waste.

This makes it possible to recover metal Fe and metal Zr having a large volume in the corium 10 and fissile nuclides and minor actinoids with high radiation dosage by separating the former from the latter. This in turn makes it possible to reduce high-level radioactive waste in volume and thereby reduce loads of storage and management.

### Second Embodiment

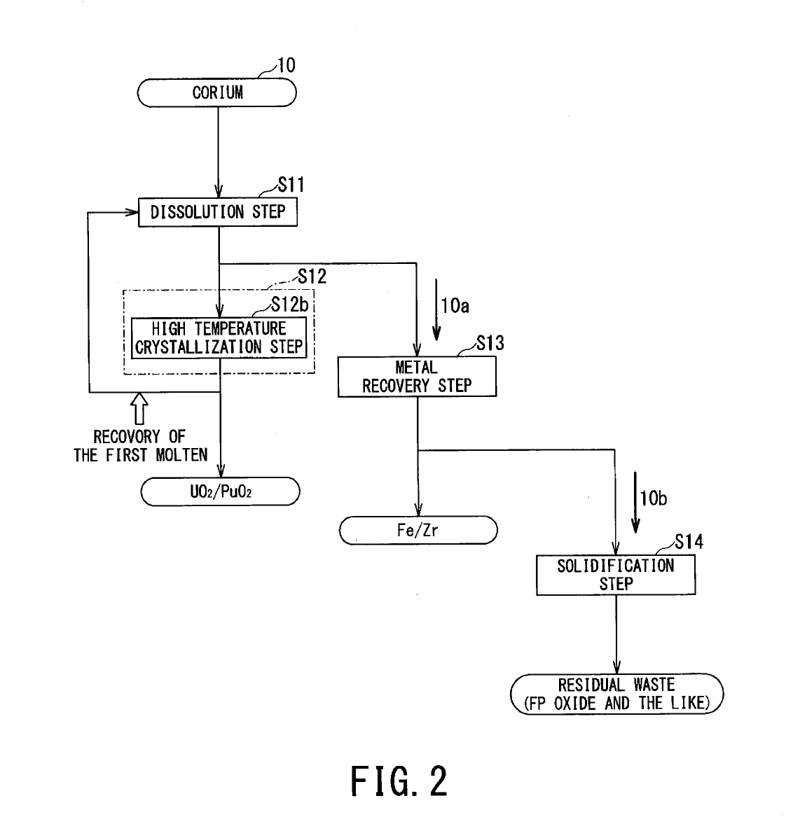

FIG. 2 is a flowchart showing a radioactive material processing method according to a second embodiment of the present invention. The processing method according to the second embodiment differs from the processing method according to the first embodiment in that the nuclear fuel recovery step S12 includes a high temperature crystallization step S12b. Note that description of processing steps similar to those of the first embodiment will be omitted.

The high temperature crystallization step S12b is designed to heat the first molten salt in which uranium oxide and plutonium oxide have dissolved to 1100C° or above and precipitate the uranium oxide and plutonium oxide using temperature dependence of solubility. This makes it possible to selectively separate and recover uranium oxide and plutonium oxide from the corium 10. Note that the first molten salt used in the high temperature crystallization step S12b can be recovered and reclaimed, and then reused in the dissolution step S11.

### Third Embodiment

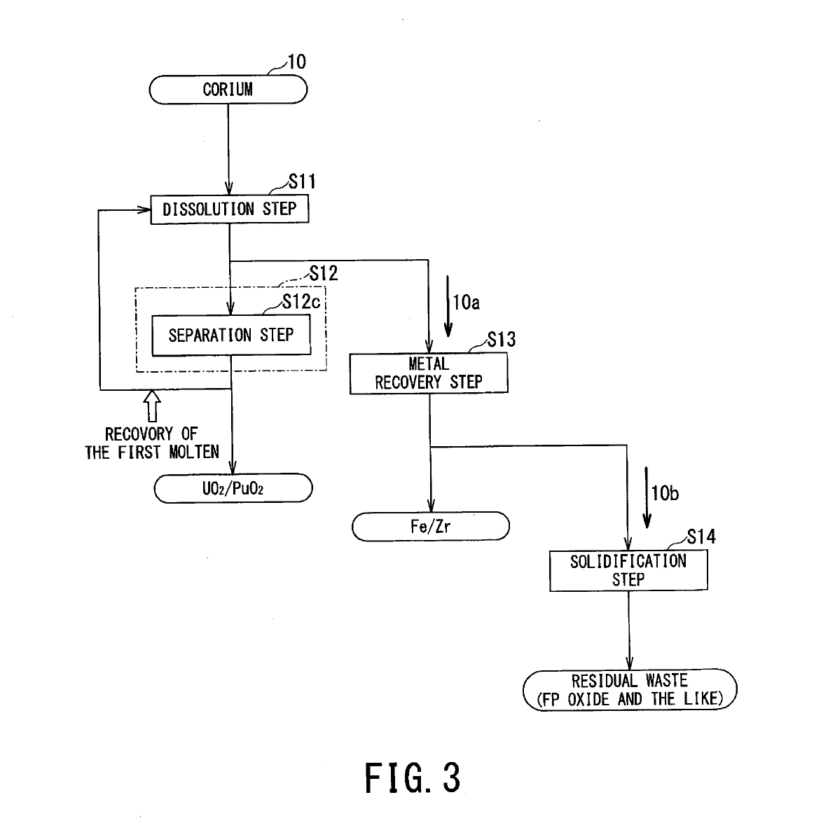

FIG. 3 is a flowchart showing a radioactive material processing method according to a third embodiment of the present invention. The processing method according to the third embodiment differs from the processing method according to the first embodiment in that the nuclear fuel recovery step S12 includes a separation step S12c. Note that description of processing steps similar to those of the first embodiment will be omitted.

In the separation step S12c, the first molten salt in which uranium oxide and plutonium oxide have dissolved is cooled and solidified, and then mixed with an acid solvent such as hydrochloric acid or nitric acid to form a water solution. Then, the ionized uranium oxide and plutonium oxide are separated using means of separation.

The means of separation here is any of a method which uses a cation exchange resin or chelate resin, a method which adds oxalic acid, and an extraction and separation method which uses an extractant such as TPB. These methods allow uranium oxide and plutonium oxide to be recovered selectively from the first molten salt. Note that the first molten salt used in the separation step S12c can be recovered and reclaimed, and then reused in the dissolution step S11.

### Fourth Embodiment

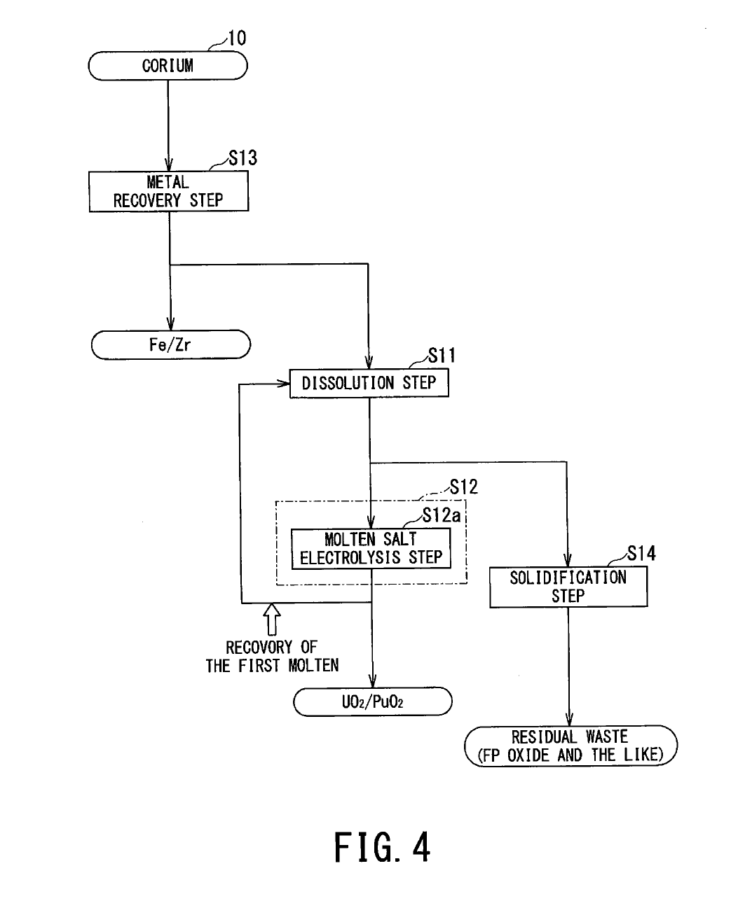

FIG. 4 is a flowchart showing a radioactive material processing method according to a fourth embodiment of the present invention. The fourth embodiment differs from the first embodiment in that the metal recovery step S13 is carried out before the dissolution step S11 of selectively dissolving uranium oxide and plutonium oxide. Note that description of processing steps similar to those of the first embodiment will be omitted.

By carrying out the dissolution step S11 in advance before the metal recovery step S13, metal Fe and metal Zr are recovered beforehand from a surface of the corium 10. This makes it possible to reduce overall volume before carrying out the dissolution step S11. This method is effective when Fe material or Zr material are adhered to or stuck in the surface of the corium 10.

Being comprised of the dissolution step S11 of dissolving the uranium oxide and plutonium oxide contained in the oxide solid into the first molten salt from the corium 10, the nuclear fuel recovery step S12 of selectively recovering the uranium oxide and the plutonium oxide from the first molten salt, and the metal recovery step S13 of recovering metal Fe and metal Zr, the radioactive material processing method according to at least one of the embodiments described above can reduce amounts of high-level radioactive waste generation and thereby reduce loads of storage and management.

Whereas a few embodiments of the present invention have been described, these embodiments are presented only by way of example, and not intended to limit the scope of the invention. These novel embodiments can be implemented in various other forms, and various omissions, replacements, and changes can be made without departing from the spirit of the invention. Such embodiments and modifications thereof are included in the spirit and scope of the invention as well as in the invention set forth in the appended claims and the scope of equivalents thereof.

### REFERENCE NUMERALS

10, 10a, 10b - - - corium

S11 - - - dissolution step

S12 - - - nuclear fuel recovery step

S12a - - - molten salt electrolysis step

S12b - - - high temperature crystallization step

S12c - - - separation step

S13 - - - metal recovery step

S14 - - - solidification step

1. A radioactive material processing method comprising:
a dissolution step of feeding a radioactive material containing metal Fe, metal Zr, uranium oxide, and plutonium oxide into a first molten salt and dissolving uranium oxide and plutonium oxide contained in an oxide solid from the radioactive material;
a nuclear fuel recovery step of recovering the uranium oxide and the plutonium oxide from the first molten salt;
a metal recovery step of feeding the radioactive material into a second molten salt and separating and recovering metal Fe and metal Zr by molten salt electrolysis; and
a solidification step of solidifying and recovering a residue of the radioactive material.

2. The radioactive material processing method according to claim 1, wherein the first molten salt is molten molybdate or molten tungstate.

3. The radioactive material processing method according to claim 1, further comprising a step of feeding the radioactive material into an acid solvent before the dissolution step to dissolve the uranium oxide and the plutonium oxide not contained in the oxide solid.

4. The radioactive material processing method according to claim 1, wherein the nuclear fuel recovery step recovers the uranium oxide and the plutonium oxide by molten salt electrolysis or high temperature crystallization, where the high temperature crystallization involves precipitating nuclear fuel material by heating the first molten salt.

5. The radioactive material processing method according to claim 1, wherein after cooling and solidifying and then dissolving the first molten salt in an acid solvent, the nuclear fuel recovery step recovers the uranium oxide and the plutonium oxide using one of separation methods: a method which uses a cation exchange resin or a chelate resin, a method which adds oxalic acid, and a method which uses an extractant for extraction and separation.
